(19) United States
(12) Patent Application Publication
(10) Pub. No.: US 2020/0191192 A1
(43) Pub. Date: Jun. 18, 2020

(54) TENSION-CONTROLLED U-BOLTS

(71) Applicant: Crown Castle USA Inc., Canonsburg, PA (US)

(72) Inventor: Matt Branagan, Canonsburg, PA (US)

(21) Appl. No.: 16/659,029

(22) Filed: Oct. 21, 2019

Related U.S. Application Data
(60) Provisional application No. 62/748,082, filed on Oct. 19, 2018.

(51) Int. Cl. F16B 39/282

(52) U.S. Cl. CPC F16B 39/282

(57) ABSTRACT

Tension-controlled U-bolts are disclosed having a curved rod with first and second threaded arms extending therefrom. A shearable spline is provided at the end of at least one of the threaded arms. An annular recessed channel is provided between the shearable spline and the threaded arm that provides a shear zone when a predetermined amount of torque is applied to the shearable spline.

### CROSS-REFERENCE TO RELATED APPLICATION

This application claims priority from U.S. Provisional Application No. 62/748,082 filed Oct. 19, 2018, which is incorporated herein by reference.

### FIELD OF THE INVENTION

The present invention provides tension-controlled U-bolts having threaded ends with shearable splines.

### BACKGROUND INFORMATION

U-bolts are steel fasteners that may be used to attach members to rounded parts, such as pipes and solid rods, such as support structures for communication towers. A typical installation involves placing the U-bolt around a pipe and another attachment and then securing the two pieces together by tightening a nut on to the threaded prongs of the U-bolt. The manner in which they are tightened is most commonly with a manual or powered wrench to the point that the nut is full seated and the components are in firm contact. This level of tightening is commonly known as “snug tight”.

In some cases, depending on the use and orientation of the attachments, the U-bolt is needed to hold a member vertically in place, e.g., preventing it from slipping or falling by means of a clamping force. One of the key components of the amount of clamping force depends on the amount of tension that is introduced into the U-bolt when tightened. The current practice to try to create the right amount of clamping force is to relate the amount of torque, e.g., the effort it took to tighten the nut a certain degree, to how much force it creates. The method of estimating a torque to produce a specified amount of tension force is highly variable and depends on many factors such as tools used, coatings used on the U-bolt, type of connection, fit up of the connection, etc.

### SUMMARY OF THE INVENTION

Tension-controlled U-bolts are provided having a curved rod with first and second threaded arms extending therefrom. A shearable spline is provided at the end of at least one of the threaded arms. An annular recessed channel is provided between the shearable spline and the threaded arm that provides a shear zone when a predetermined amount of torque is applied to the shearable spline.

An aspect of the present invention provides a tension-controlled U-bolt comprising a curved rod, a first substantially straight threaded arm extending in a first extension direction from a first end of the curved rod, a second substantially straight threaded arm extending from a second end of the curved rod in a second extension direction substantially parallel with the first extension direction of the first threaded arm, and a first shearable spline extending from the first threaded arm having a first central spline axis aligned with the first extension direction of the first threaded arm, wherein the first shearable spline is structured and arranged to be sheared away from the first threaded arm upon application of a first predetermined amount of torque to the first shearable spline.

A further aspect of the present invention provides a tension-controlled U-bolt comprising a curved rod, a first substantially straight threaded arm extending in a first extension direction from a first end of the curved rod, a first shearable spline extending from the first threaded arm having a first central spline axis aligned with the first extension direction of the first threaded arm, a second substantially straight threaded arm extending from a second end of the curved rod in a second extension direction substantially parallel with the first extension direction of the first threaded arm, and a second shearable spline extending from the second threaded arm having a second central spline axis aligned with the second extension direction of the second threaded arm.

Another aspect of the present invention provides a method of making the tension-controlled U-bolt as described above. The method includes providing a substantially straight rod, threading a first end of the substantially straight rod to form the first substantially straight threaded arm, forming the first shearable spline on the end of the first threaded arm, and bending the substantially straight rod to form the curved rod of the U-bolt.

A further aspect of the present invention provides a method of securing a tension-controlled U-bolt as described above to a support structure. The method includes placing the curved rod of the U-bolt around the support structure, tightening a second nut on the second threaded arm, and tightening a first nut on the first threaded arm to thereby apply the first predetermined amount of torque sufficient to shear the first shearable spline away from the first threaded arm.

These and other aspects of the present invention will be more apparent from the following description.

### BRIEF DESCRIPTION OF THE DRAWINGS

FIG. 1 is an isometric view of a tension-controlled U-bolt assembly installed on a support structure in accordance with an embodiment of the present invention.

FIG. 2 is a side view illustrating components of a tension-controlled U-bolt assembly in accordance with an embodiment of the present invention.

FIG. 3 is a side view illustrating components of a tension-controlled U-bolt assembly in accordance with another embodiment of the present invention.

### DETAILED DESCRIPTION

To address issues of variability, as well as improve ease of installation and inspection of tightened U-bolts, the present invention provides a shearable tension controlled spline on at least one end of a U-bolt. A conventional tension control shear wrench known to those skilled in the art (also known as a TC wrench, TC gun or shear wrench) may be used to fasten the U-bolt. A tension-controlled spline works by the principle that the torsional twist of a bolt and the resulting elongation of the bolt that is directly proportionate to the amount of tension force that is induced into the bolt. The spline is designed to shear off at the end of the fastener when a specific amount of force is induced in the bolt but prior to damaging the bolt or overtightening it past the desired amount. The direct amount of tension is obtained with the tool rather than trying to obtain a specific torque that is correlated to a tension value.

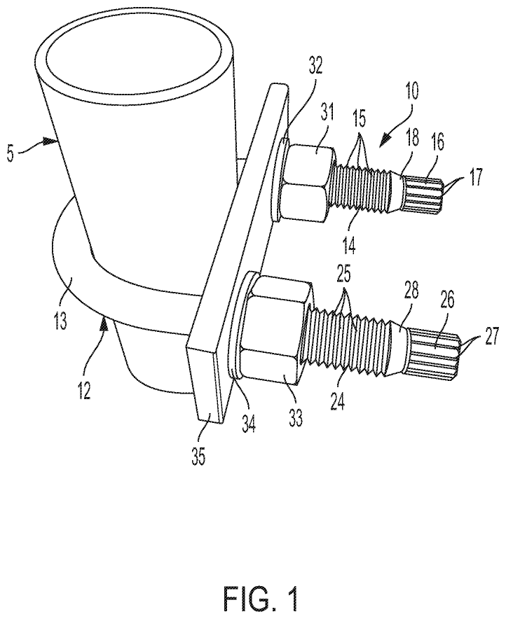

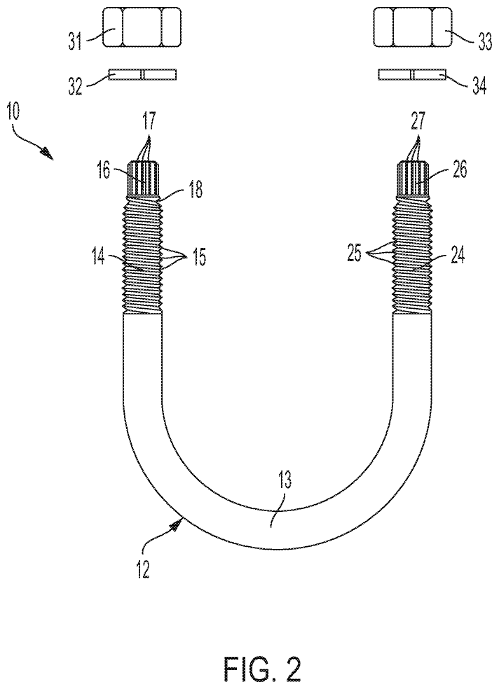

FIGS. 1 and 2 illustrate a tension-controlled U-bolt assembly 10 in accordance with an embodiment of the present invention. As shown in FIG. 1, the tension-controlled U-bolt assembly 10 may be secured to a support structure 5 such as a round pipe support pole. The tension-controlled U-bolt assembly 10 includes a tension-controlled U-bolt 12 having a curved rod 13, first threaded arm 14 and second threaded arm 24. The first and second threaded arms 14 and 24 are substantially straight and extend away from the curved rod 13 in parallel directions. The first threaded arm 14 includes first thread channels 15. A first shearable spline 16 extends from the end of the first threaded arm 14. The first shearable spline 16 includes first spline channels 17. A first annular recessed channel 18 is provided on the first shearable spline 16 adjacent to the first threaded arm 14. As more fully described below, the first annular recessed channel 18 provides a shear zone for the sharing of the first shearable spline 16 away from the first threaded arm 14 upon application of a predetermined amount of torque to the first shearable spline 16 during installation of the tension-controlled U-bolt assembly 10 on a support structure.

As further shown in FIGS. 1 and 2, the tension-controlled U-bolt assembly 10 includes a second threaded arm 24 extending from the curved rod 13 having thread channels 25. A second shearable spline 26 extends from the end of the second threaded arm 24. The second shearable spline 26 includes seconds spline channels 27. A second annular recessed channel 28 is provided on the second shearable spline 26 adjacent to the second threaded arm. The second annular recessed channel 28 provides a shear zone for sharing the second shearable spline 26 away from the second threaded arm 24 upon application of a predetermined amount of torque to the second shearable spline 26.

As further shown in FIGS. 1 and 2, the first annular recessed channel 18 extends radially inward further than the first thread channels 15 and further than the first spline channels 17. Similarly, the second annular recessed channel 28 extends radially inward further than the second thread channels 25 and further than the second spline channels 27. In FIG. 1, the first and second annular recessed channels 18 and 28 have generally U-shaped cross sections, while in FIG. 2 they have generally V-shaped cross sections.

As shown in FIGS. 1 and 2, the tension-controlled U-bolt assembly 10 includes a first nut 31, first washer 32, second nut 33 and second washer 34. The first nut 31 may be threaded on the first threaded arm 14, and the second nut 33 may be threaded on the second threaded arm 24. As shown in FIG. 1, a crossbar 35 may be provided through which the first and second threaded arms 14 and 24 of the U-bolt 12 extend.

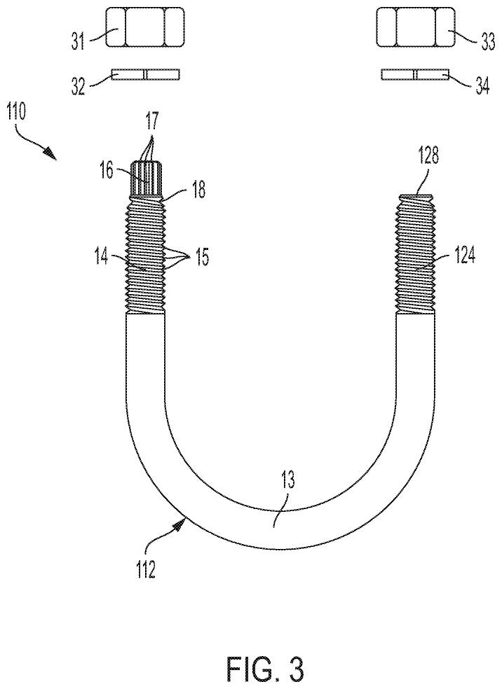

FIG. 3 illustrates a tension-controlled U-bolt assembly 110 in accordance with another embodiment of the present invention. In this embodiment, the tension-controlled U-bolt 112 includes a first threaded arm 14 having a first shearable spline 16, similar to the embodiment of FIG. 2. However, a second threaded arm 124 is provided with a terminal end 128 that does not include a shearable spline. Thus, the tension-controlled U-bolt 112 shown in FIG. 3 provides a single shearable spline 116, rather than the double shearable spline embodiment of FIGS. 1 and 2.

In accordance with embodiments of the present invention, a relatively deep channel cut of the annular recessed channels 18 and 28 may be provided between the spline end(s) and threaded portion(s) of the U-bolts as shown in FIGS. 1-3. The relatively deep annular recessed channels 18 and 28 allow the spline end(s) to shear off with a reduced or controlled amount of force during installation with a tension control shear wrench. The threaded portions, spline(s) and annular channel cut(s) may be formed when the body of the bolt is in a straight configuration, followed by bending of the unthreaded portion of the bolt into a U-shape. A conventional tension control shear wrenches may be used to tighten the tension-controlled U-bolts of the present invention.

Whereas particular embodiments of this invention have been described above for purposes of illustration, it will be evident to those skilled in the art that numerous variations of the details of the present invention may be made without departing from the invention.

What is claimed is:

1. A tension-controlled U-bolt comprising:
a curved rod;
a first substantially straight threaded arm extending in a first extension direction from a first end of the curved rod;
a second substantially straight threaded arm extending from a second end of the curved rod in a second extension direction substantially parallel with the first extension direction of the first threaded arm; and
a first shearable spline extending from the first threaded arm having a first central spline axis aligned with the first extension direction of the first threaded arm,
wherein the first shearable spline is structured and arranged to be sheared away from the first threaded arm upon application of a first predetermined amount of torque to the first shearable spline.

2. The tension-controlled U-bolt of claim 1, wherein the first shearable spline includes a first annular recessed channel located adjacent to the first threaded arm that provides a shear zone for the shearing of the first shearable spline away from the first threaded arm.

3. The tension-controlled U-bolt of claim 2, wherein the first annular recessed channel extends radially inward further than spline channels of the first shearable spline.

4. The tension-controlled U-bolt of claim 2, wherein the first annular recessed channel extends radially inward further than thread channels of the first threaded arm.

5. The tension-controlled U-bolt of claim 2, wherein the first annular recessed channel extends radially inward further than spline channels of the first shearable spline and further than thread channels of the first threaded arm.

6. The tension-controlled U-bolt of claim 1, wherein the first predetermined amount of torque is applied to the first shearable spline by a tension control shear wrench.

7. The tension-controlled U-bolt of claim 1, further comprising a second shearable spline extending from the second threaded arm having a second central spline axis aligned with the second extension direction of the second threaded arm, wherein the second shearable spline is structured and arranged to be sheared away from the second threaded arm upon application of a second predetermined amount of torque to the second shearable spline.

8. The tension-controlled U-bolt of claim 7, wherein the first and second predetermined amounts of torque are the same.

9. The tension-controlled U-bolt of claim 7, wherein the second shearable spline includes a second annular recessed channel located adjacent to the second threaded arm that provides a shear zone for the shearing of the second shearable spline away from the second threaded arm.

10. The tension-controlled U-bolt of claim 9, wherein the second annular recessed channel extends radially inward further than spline channels of the second shearable spline.

11. The tension-controlled U-bolt of claim 9, wherein the second annular recessed channel extends radially inward further than thread channels of the second threaded arm.

12. The tension-controlled U-bolt of claim 9, wherein the second annular recessed channel extends radially inward further than spline channels of the second shearable spline and further than thread channels of the second threaded arm.

13. The tension-controlled U-bolt of claim 1, wherein the curved rod is structured and arranged to partially surround a support structure.

14. A tension-controlled U-bolt comprising:
a curved rod;
a first substantially straight threaded arm extending in a first extension direction from a first end of the curved rod;
a first shearable spline extending from the first threaded arm having a first central spline axis aligned with the first extension direction of the first threaded arm;
a second substantially straight threaded arm extending from a second end of the curved rod in a second extension direction substantially parallel with the first extension direction of the first threaded arm; and
a second shearable spline extending from the second threaded arm having a second central spline axis aligned with the second extension direction of the second threaded arm.

15. The tension-controlled U-bolt of claim 14, wherein the first shearable spline includes a first annular recessed channel located adjacent to the first threaded arm that provides a shear zone for shearing of the first shearable spline away from the first threaded arm, and the second shearable spline includes a second annular recessed channel located adjacent to the second threaded arm that provides a shear zone for shearing of the second shearable spline away from the second threaded arm.

16. The tension-controlled U-bolt of claim 15, wherein the first annular recessed channel extends radially inward further than spline channels of the first shearable spline and further than thread channels of the first threaded arm, and the second annular recessed channel extends radially inward further than spline channels of the second shearable spline and further than thread channels of the second threaded arm.

17. A method of making a tension-controlled U-bolt of claim 1, the method comprising:
providing a substantially straight rod;
threading a first end of the substantially straight rod to form the first substantially straight threaded arm;
forming the first shearable spline on the end of the first threaded arm; and
bending the substantially straight rod to form the curved rod of the U-bolt.

18. A method of securing a tension-controlled U-bolt of claim 1 to a support structure, the method comprising:
placing the curved rod of the U-bolt around the support structure;
tightening a second nut on the second threaded arm; and
tightening a first nut on the first threaded arm to thereby apply the first predetermined amount of torque sufficient to shear the first shearable spline away from the first threaded arm.

19. The method of securing a tension-controlled U-bolt of claim 18, wherein the first predetermined amount of torque is applied to the first shearable spline by a tension control shear wrench.

20. The method of securing a tension-controlled U-bolt of claim 18, wherein the tension-controlled U-bolt further comprises a second shearable spline extending from the second threaded arm having a second central spline axis aligned with the second extension direction of the second threaded arm, the second shearable spline is structured and arranged to be sheared away from the second threaded arm upon application of a second predetermined amount of torque to the second shearable spline, and the tightening of the second nut on the second threaded arm thereby applies the second predetermined amount of torque sufficient to shear the second shearable spline away from the second threaded arm.
